(19) United States
(12) Patent Application Publication
(10) Pub. No.: US 2014/0105703 A1
(43) Pub. Date: Apr. 17, 2014

(54) Encapsulated Load-Securement Bulkhead and Method of Manufacture

(71) Applicants: Eric Daniel Kvilhaug, Winters, CA (US); Michael Edward Moore, Silverdale, CA (US)

(72) Inventors: Eric Daniel Kvilhaug, Winters, CA (US); Michael Edward Moore, Silverdale, CA (US)

(21) Appl. No.: 14/133,306

(22) Filed: Dec. 18, 2013

Related U.S. Application Data
(63) Continuation-in-part of application No. 12/925,500, filed on Oct. 22, 2010, now abandoned.

(51) Int. Cl. B60P 7/135

(52) U.S. Cl. CPC B60P 7/135
USPC 410/121; 427/372.2

(57) ABSTRACT

An encapsulated bulkhead for use as a void filler to secure and protect cargo loads during transportation, such as in rail cars or trucks, is described. The encapsulated bulkhead includes a bulkhead member and an encapsulation or coating. In one embodiment, the bulkhead member includes two planar parallel deck sheets, a planar peripheral side member, and a honeycomb cell core, which may be made of corrugated paper or other paper. In another embodiment, the bulkhead member is a uniform expanded polypropylene. The coating is a water-resistant material which may be an elastomer, such as a polyurea, polyurethane, or polyurethane/polyurea hybrid. A method for encapsulating a bulkhead member is also provided. The method includes the steps of providing a bulkhead member, spraying the bulkhead member with the components of an elastomer to coat or encapsulate the bulkhead, and allowing the components to cure for a period of time sufficient to form the water-resistant elastomer.

### CROSS-REFERENCE TO RELATED APPLICATION

Pursuant to 35 U.S.C. §120, this application is a continuation-in-part of and claims priority to co-pending U.S. patent application Ser. No. 12/925,500 filed on Oct. 22, 2010, the entire disclosure of which is incorporated herein by reference.

### BACKGROUND OF THE INVENTION

1. Field of the Invention

This application is a continuation-in-part patent application of U.S. patent application Ser. No. 12/925,500, filed Oct. 22, 2010, currently pending and which is hereby incorporated by reference herein in its entirety.

This invention relates generally to bulkheads used in securing and protecting cargo loads during transportation, and in particular, to reusable, water-resistant encapsulated bulkheads.

2. Description of the Related Art

Bulkheads are used to protect and secure cargo loads during transportation in, for example, rail cars, trucks, and shipping containers. The cargo loads, such as food or beverages in cans, bottles, large bins, or other containers, or fruits, vegetables, or frozen foods in crates, boxes, or other containers, are typically placed on pallets which are lined up next to each other and may be stacked on top of one another. Bulkheads are most often used to protect cargo loads from longitudinal or length-wise forces, such as occur when rail cars are coupled and uncoupled from each other. The bulkhead must be strong enough to absorb the shock of the impact such that the force of the impact does not transfer to the cargo load causing the cargo load to become damaged or crushed.

The existing bulkheads include paper bulkheads and plastic bulkheads. One problem of paper bulkheads is that they are not water-resistant. If these bulkheads are stored outside, as frequently occurs, they will break down in conditions of humidity or rain, and cannot be reused. Another problem of paper bulkheads is that they are not very strong and are easily damaged or destroyed when being moved or transported. Plastic bulkheads are water-resistant and less easily damaged during transportation, but suffer from the problem of being very rigid and not absorbing shock as well as paper bulkheads, thus transferring the force of impact to the cargo load. Another problem of plastic bulkheads is that they are far more costly than paper bulkheads.

Thus, there is a need for a bulkhead that overcomes one or more of the significant problems of the known prior art.

### SUMMARY OF THE INVENTION

In one aspect, an embodiment of the invention overcomes one or more of the problems of the known prior art by providing an encapsulated bulkhead. The encapsulated bulkhead is strong, absorbs shock without transferring the force of impact to the cargo loads, is water-resistant and reusable, and is economically feasible.

The encapsulated bulkhead comprises a bulkhead member and a unitary encapsulation or coating. In an embodiment, the bulkhead member comprises two planar substantially parallel deck sheets, a planar peripheral side member, and an intermediate honeycomb cell core, all made of corrugated paper. In another embodiment, the deck sheets and side member are made of non-corrugated Kraft paper, solid fiber paper, or chipboard paper, and the core is made of corrugated paper. In a further embodiment, the bulkhead member comprises a uniform, integrally formed, expanded polypropylene. The unitary encapsulation or coating is adhered to and surrounds the bulkhead member. The coating is a water-resistant material which may be an elastomer, such as a polyurea, a polyurethane, or a polyurethane/polyurea hybrid, and may include an elongation factor to prevent the material from cracking and shearing and to prevent the coating from peeling off the bulkhead member.

In another aspect, a method for encapsulating a bulkhead member is provided. The method comprises the following steps: providing a bulkhead member comprising a first planar face, a second planar face spaced apart from and substantially parallel to the first planar face, and an outer peripheral side face; spraying the components of an elastomer onto an entirety of the first planar face, the second planar face, and the outer peripheral side face for encapsulating the bulkhead member; and allowing the sprayed components to cure for a period of time sufficient for forming the elastomer.

In one embodiment, the encapsulated bulkhead is used as a void filler to secure and protect cargo loads to prevent damage to the cargo during transportation. The encapsulated bulkhead may be used in rail cars, trucks, or shipping containers. For example, the encapsulated bulkhead may be used in rail cars to protect cargo from the longitudinal forces caused by the coupling and uncoupling of rail cars.

### BRIEF DESCRIPTION OF THE DRAWINGS

FIG. 1 is a side perspective partially cut-away view of an embodiment of an encapsulated bulkhead.

FIG. 2 is a close-up view of that which is encircled by dashed line 2 shown in FIG. 1.

FIG. 3 is a close-up view of a portion of the core of the encapsulated bulkhead encircled by dashed line 3 shown in FIG. 1.

FIG. 4 is a cross-section of the encapsulated bulkhead taken along line 4-4 of FIG. 1.

FIG. 5 is a close-up view of that which is encircled by dashed line 5 shown in FIG. 4.

FIG. 6 is a cross-section of the encapsulated bulkhead taken along line 6-6 of FIG. 1.

FIG. 7 is another side perspective partially cut-away view of the encapsulated bulkhead shown in FIG. 1.

FIG. 8 is a side perspective view of the core of the encapsulated bulkhead shown in FIG. 1.

FIG. 9 is a side perspective partially cut-away view of another embodiment of an encapsulated bulkhead.

FIG. 10 is a close-up view of that which is encircled by dashed line 10 shown in FIG. 9.

FIG. 11 is a close-up view of a portion of the core of the encapsulated bulkhead encircled by dashed line 11 shown in FIG. 9.

FIG. 12 is a cross-section of the encapsulated bulkhead taken along line 12-12 of FIG. 9.

FIG. 13 is a close-up view of that which is encircled by dashed line 13 shown in FIG. 12.

FIG. 14 is a cross-section of the encapsulated bulkhead taken along line 14-14 of FIG. 9.

FIG. 15 is another side perspective partially cut-away view of the encapsulated bulkhead shown in FIG. 9.

FIG. 16 is a side perspective view of the core of the encapsulated bulkhead shown in FIG. 9.

FIG. 17 is a side perspective partially cut-away view of a further embodiment of an encapsulated bulkhead.

FIG. 18 is a side perspective view of the bulkhead member of the encapsulated bulkhead shown in FIG. 17.

FIG. 19 is a cross-section of the encapsulated bulkhead taken along line 19-19 of FIG. 17.

FIG. 20 is a cross-section of the encapsulated bulkhead taken along line 20-20 of FIG. 17.

FIG. 21 is a diagrammatic view of an embodiment of a system used in the spraying step in making the encapsulated bulkhead shown in FIGS. 1, 9, and 17.

FIG. 22 is a side elevational view of a rail car showing placement of an embodiment of an encapsulated bulkhead.

FIG. 23 is a top elevational view of the rail car shown in FIG. 22.

### DETAILED DESCRIPTION OF THE INVENTION

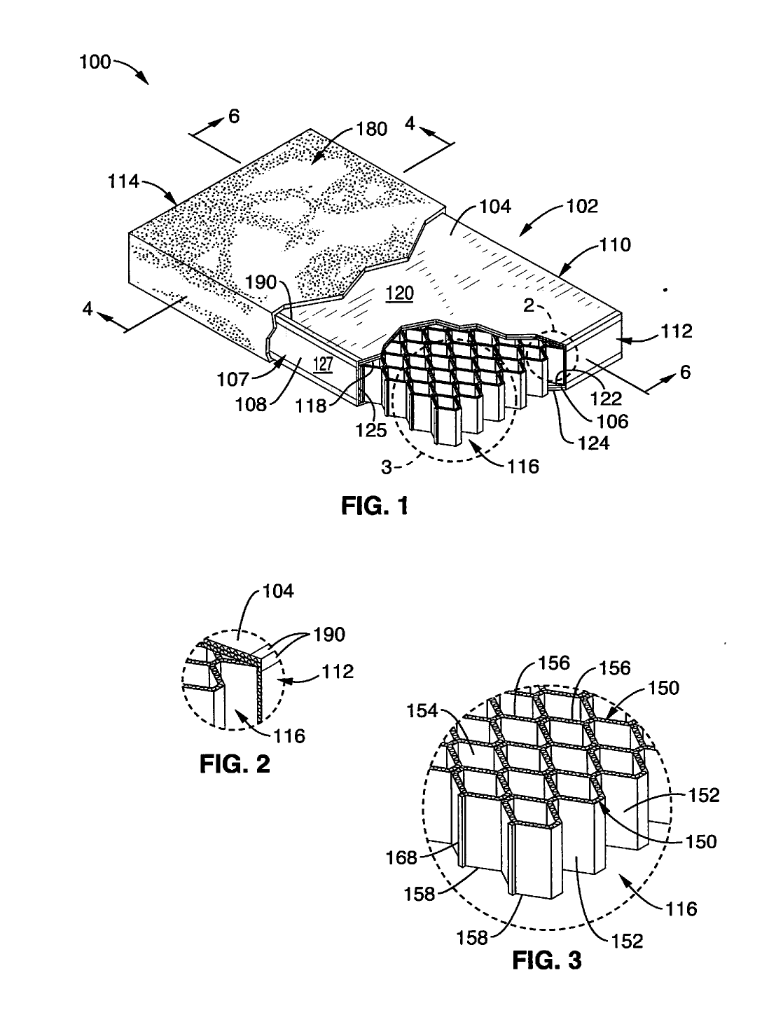

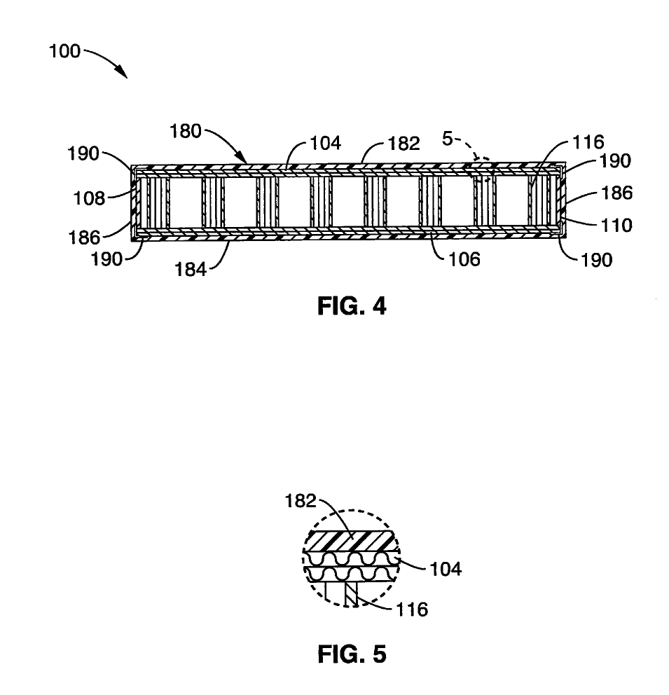

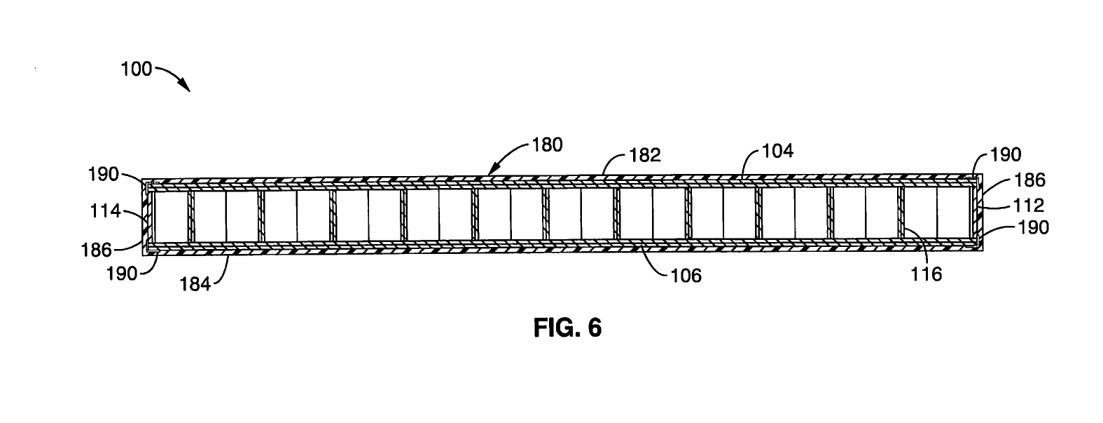

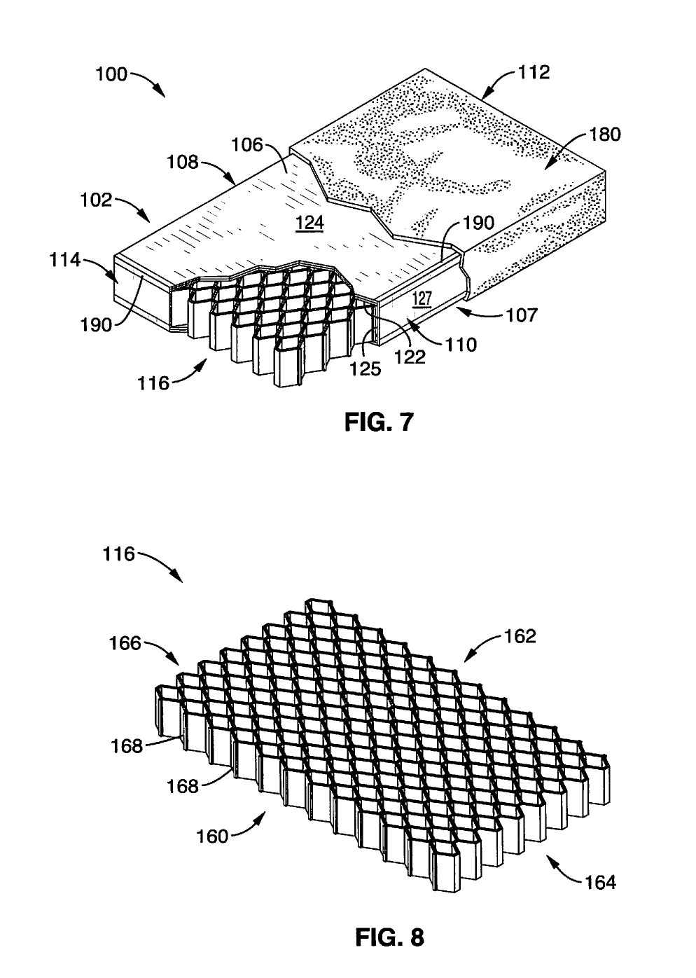

As illustrated in FIGS. 1 through 8, in one embodiment, encapsulated bulkhead 100 comprises bulkhead member 102 and encapsulation or coating 180. Encapsulated bulkhead 100 may be any three-dimensional geometric shape, such as a shape having rectangular, square, or other shaped sides, that is complemental to the shape of the space it is being used to fill. In the illustrated embodiment, encapsulated bulkhead 100 has rectangular sides. Bulkhead member 102 is comprised of first and second planar substantially parallel deck sheets 104 and 106, respectively, planar peripheral side member 107, and core 116.

Deck sheets 104 and 106 each have a substantially flat inner surface 118 and 122, respectively, and a substantially flat outer surface 120 and 124, respectively. Deck sheets 104 and 106 sandwich core 116 such that inner surfaces 118 and 122 are adjacent to core 116 and outer surfaces 120 and 124 are adjacent to coating 180. In the illustrated embodiment, deck sheets 104 and 106 are rectangular. In one embodiment, deck sheets 104 and 106 are preferably made of double-walled, 350 lb. corrugated paper (manufactured by, for example, Georgia-Pacific), although they may be made of non-test (single-walled) corrugated paper, or other materials.

Peripheral side member 107 has a substantially flat inner surface 125 and a substantially flat outer surface 127. Peripheral side member 107 comprises first and second planar substantially parallel side portions 108 and 110, respectively, and first and second planar substantially parallel end portions 112 and 114, respectively. Inner surface 125 is adjacent to core 116. Outer surface 127 is adjacent to coating 180. In the illustrated embodiment, side portions 108 and 110 and end portions 112 and 114 are rectangular. In one embodiment, peripheral side member 107 is preferably made of non-test (single-walled) corrugated paper (manufactured by, for example Georgia-Pacific), although it may be made of other materials. Peripheral side member 107 may be formed of one continuous length of material or it may be formed by multiple lengths of material joined together by, for example, joining four separate pieces comprised of side portions 108 and 110 and end portions 112 and 114.

Peripheral side member 107 is substantially perpendicular to deck sheets 104 and 106, and circumscribes core 116. Together, deck sheets 104 and 106 and peripheral side member 107 enclose core 116.

Core 116 is an array of four-sided cells 150 arranged like a honeycomb. The shape of core 116 corresponds to the shape of bulkhead 100. For example, if bulkhead 100 rectangular, then core 116 is also rectangular. Cells 150 are preferably square, but may be diamond shaped. Each cell 150 has four walls 152 which define an opening 154. Each cell 150 has a plurality of first face edges 156 and a plurality of second face edges 158. First face edges 156 are spaced apart from and are substantially parallel to second face edges 158. Core 116 has first side 160 and second side 162, and first end 164 and second end 166. Sides 160 and 162 and ends 164 and 166 are formed by the walls 152 of those cells 150 located on the periphery of core 116, thereby defining a plurality of peripheral cells. The peripheral cells have a plurality of spaced apart peripheral side edges 168. Peripheral side edges 168 are substantially perpendicular to the first and second face edges 156 and 158, respectively. Core 116 is sandwiched between first deck sheet 104 and second deck sheet 106 such that first and second deck sheets 104 and 106 are substantially perpendicular to walls 152 of cells 150. A plurality of first face edges 156 are attached to inner surface 118 of first deck sheet 104 and a plurality of second face edges 158 are attached to inner surface 122 of second deck sheet 106. Sides 160 and 162 and ends 164 and 166 are attached to inner surface 125 of peripheral side member 107 by a plurality of peripheral side edges 168. In one embodiment, core 116 is preferably made of non-test (single-walled) corrugated paper (manufactured by, for example, Georgia-Pacific), although it may be made of non-corrugated Kraft paper or other materials.

The size of cells 150 is preferably 2½ inches to 5½ inches, and most preferably 3% inches, measured as the length of one wall 152. Other cell sizes may be useful, including larger sizes or smaller sizes such as ⅜ to 1 inch.

Core 116 is adhered to deck sheets 104 and 106 of bulkhead member 102 with glue (Pacific Adhesives, PKG 3238 DX) or other adhesives. Core 116 is coupled to side portions 108 and 110 and end portions 112 and 114 of bulkhead member 102 with, for example, an adhesive or tape 190 coupling.

Bulkhead member 102 may be made any size that is useful for securing a particular load in a particular container. One size that is useful is a rectangle that is 45 inches wide by 89 inches long by 8 inches thick.

Encapsulation or coating 180 is preferably a unitary encapsulation or coating. Coating 180 is a water-resistant durable material, which may be in the form of, but is not limited to, an elastomer such as a polyurea, a polyurethane, or a polyurethane/polyurea hybrid polymer. The components of coating 180 are directly applied to bulkhead member 102 in liquid form in one or more coats and then allowed to cure. Curing can be done under, for example, conditions of ambient humidity and temperature. Polyurea is defined as the product of a reaction between an isocyanate and a synthetic resin blend, which may be an amine resin blend. Polyurethane is defined as the product of a reaction between an isocyanate and polyol. A polyurethane/polyurea hybrid is defined as the product of a reaction between an isocyanate and a polyol/amine in varying percentages. In one embodiment, it is preferred that the coating is in the form of a polyurea such as, but not limited to, VF-F55 (Versaflex Incorporated), which comprises two components, referred to as component A and component B. When mixed together, component A and component B form a polyurea. Component A of VF-F55 is 100% isocyanate and component B is an amine resin blend. Component B includes an elongation factor which helps make coating 180 less rigid and more flexible such that it remains adhered to bulkhead member 102 and will not crack or delaminate from bulkhead member 102 due to shear forces.

Encapsulation or coating 180 comprises a first face 182, a second face 184, and a circumscribing side face 186. Circumscribing side face 186 extends between and transitions into first face 182 and second face 184. Coating 180 is adhered to and covers the outside of bulkhead member 102, preferably, in its entirety. First face 182 is adhered to and covers outer surface 120 of deck sheet 104. Second face 184 is adhered to and covers outer surface 124 of deck sheet 106. Circumscribing side face 186 is adhered to and covers outer surface 127 of peripheral side member 107. The thickness of coating 180 may be about 0.040-0.045 inches, but other thicknesses may be useful. Increasing the thickness of coating 180 increases the strength of encapsulated bulkhead 100, although increasing the thickness of coating 180 may increase the cost of bulkhead 100.

Bulkhead member 102 may be formed by the following steps. Core 116 is made of a plurality of sheets of paper of the same size, preferably non-test (single walled) corrugated paper. The size of each sheet is such that the length of the sheet becomes the width of the core 116 once completed. The width of core 116 once completed is somewhat less than the length of the sheet due to the fact that the sheet's length forms the walls of adjacent cells 150 of core 116. For example, a sheet that is 56 inches long will become part of a core 116 that is 45 inches wide. The width of the sheet may be any width that is divisible by a number equal to the desired thickness of the core 116. For example, a sheet that is 48 inches wide can be divided into six equal portions that are each 8 inches wide to be used in six cores 116 that are each 8 inches thick, or it can be divided into 12 equal portions that are each 4 inches wide to be used in 12 cores 116 that are each 4 inches thick, or it can be divided into other portions to be used in cores 116.

The sheets are fed into a laminator (AP&R Machine) which applies multiple glue lines to the top of each sheet, such that the glue lines are parallel to the width of each sheet. The glue lines are spaced apart a distance equal to twice the length of one wall 152 of the cells 150 of the core 116. For example, if the cell walls 152 are to be 2½ inches long, then the glue lines should be placed 5 inches apart. The pattern of glue lines alternates on successive sheets. For example, if the glue lines are placed at 5 inches, 10 inches, 15 inches, 20 inches, etc. on the first sheet, then they will be placed at 2½ inches, 7½ inches, 12½ inches, and 17 1/2 inches, etc. on the second sheet, and continuing to alternate on each sheet.

The laminator stacks multiple sheets with glue lines on them to form slabs. The number of sheets in a slab is called the ply and determines the length of bulkhead member 102. For a bulkhead member 102 that is to be 89 inches long, the slab is about 50 ply. The laminator stacks several slabs onto a pallet and applies 1000 pounds of downward pressure onto the slabs. The pressure is applied for at least 15 minutes to allow the glue to dry.

Each slab is then cut to divide its thickness into strips with a bandsaw. The width of the strips corresponds to the thickness of the completed bulkhead member 102. For example, if bulkhead number 102 is to be 8 inches thick, then the slab is preferably 48 inches thick and is cut into six 8 inches wide strips. Each strip, after it is stretched open to create the cells 150, will become a core 116. Each strip is then run through a glue spreader (Black Brothers) which spreads glue on both the top and bottom of the strip. The glue is preferably a dextrin glue.

Deck sheets 104 and 106 are purchased precut to the final size or are cut to the final size. For example, if bulkhead member 102 is to be 45 inches wide by 89 inches long, deck sheets 104 and 106 are cut to 45 inches by 89 inches One of the deck sheets, for example, deck sheet 106, is laid down on a flat surface, preferably on an elevated roller platform. Then the core strip is manually stretched to open up cells 150, to become core 116. The core strip is stretched such that its size matches the size of deck sheet 106. The core 116 is then laid on top of deck sheet 106 such that the glue on the bottom of core 116 contacts deck sheet 106 and adheres the two together. The other deck sheet, for example, deck sheet 104, is placed on top of core 116 such that the glue on the top of core 116 contacts deck sheet 104 and adheres the two together.

The partial bulkhead members comprising deck sheets 104 and 106 sandwiching core 116 are stacked onto a pallet. A full pallet of the partial bulkhead members is then placed in a press (AP&R Machine) and the partial bulkhead members are subjected to 2000 pounds of downward pressure for at least five minutes to allow the glue to set.

Peripheral side member 107 is then attached to the partial bulkhead member to form bulkhead member 102. This can be accomplished by heavy-duty tape 190, such as 3M, that is placed to substantially cover all seams or junctions where deck sheets 104 and 106 meet peripheral side member 107. Other methods of adhesion may be used as long as the junction of peripheral side member 107 with deck sheets 104 and 106 substantially covered. Bulkhead member 102 is then ready to be sprayed with coating 180.

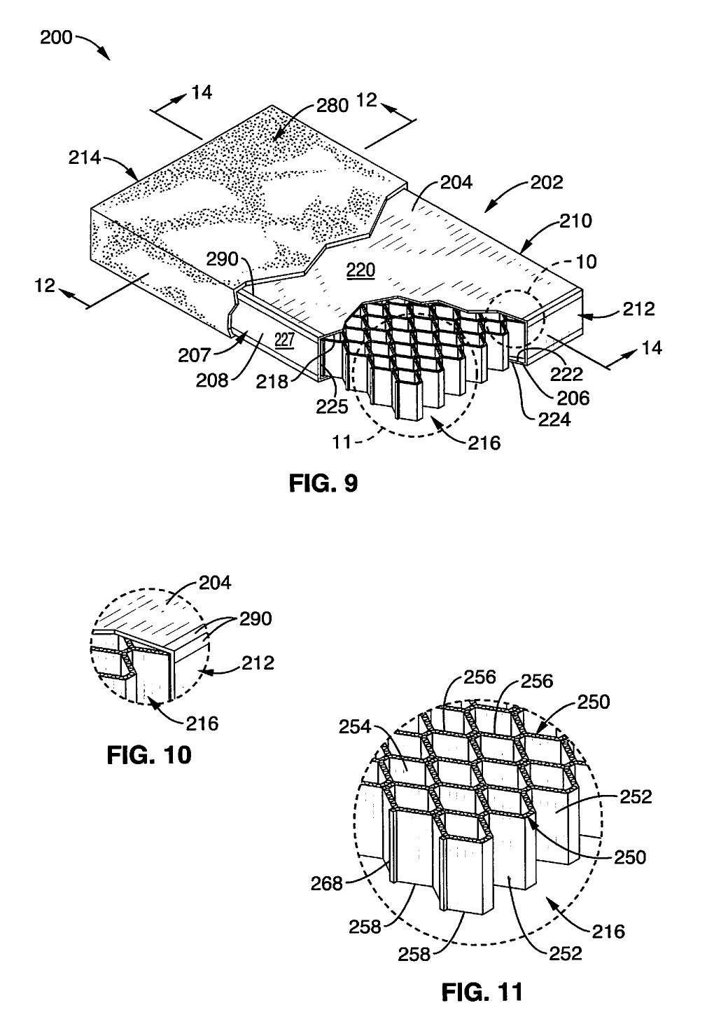

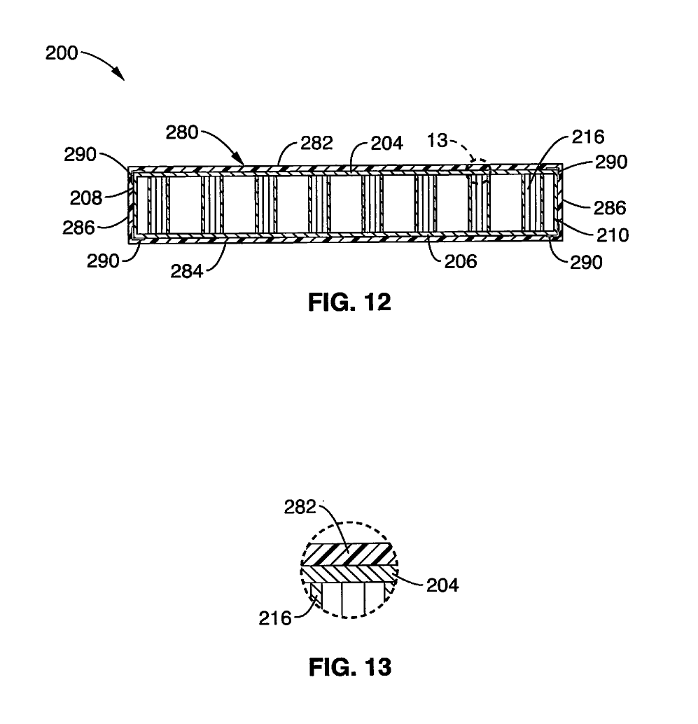

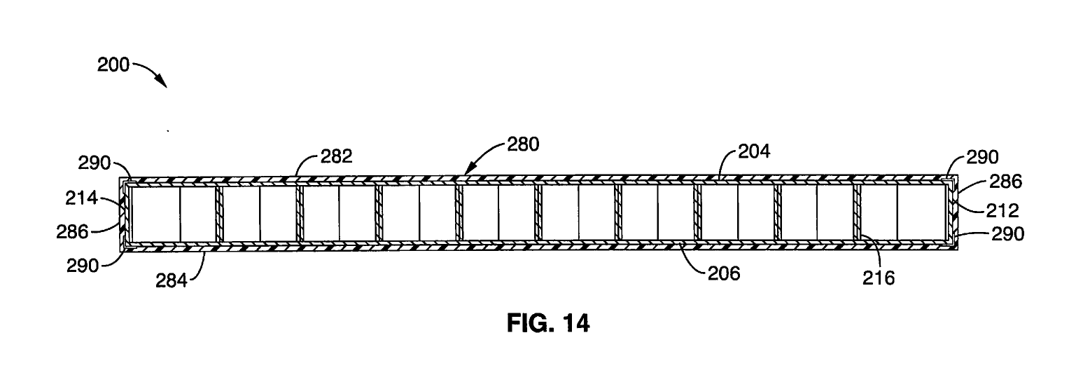

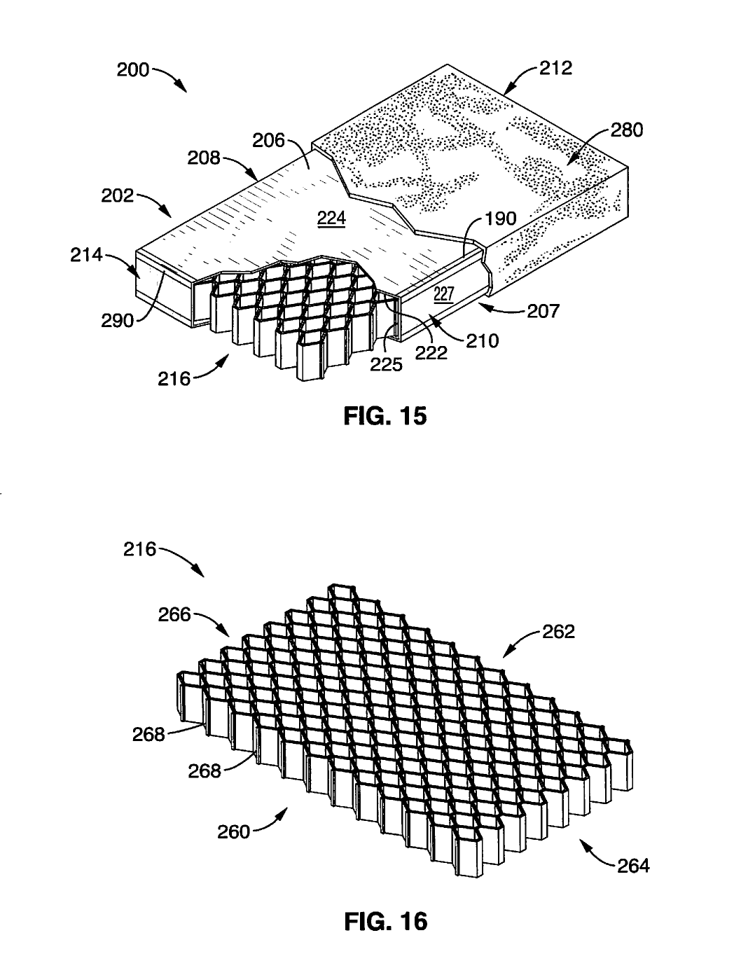

As illustrated in FIGS. 9 through 16, and in another embodiment, encapsulated bulkhead 200 comprises bulkhead member 202 and encapsulation or coating 280. Encapsulated bulkhead 200 may be any three-dimensional geometric shape, such as a shape having rectangular, square, or other shaped sides, that is complemental to the shape of the space it is being used to fill. In the illustrated embodiment, encapsulated bulkhead 100 has rectangular sides. Bulkhead member 202 is comprised of first and second planar substantially parallel deck sheets 204 and 206, respectively, planar peripheral side member 207, and core 216.

Deck sheets 204 and 206 each have a substantially flat inner surface 218 and 222, respectively, and a substantially flat outer surface 220 and 224, respectively. Deck sheets 204 and 206 sandwich core 216 such that inner surfaces 218 and 222 are adjacent to core 216 and outer surfaces 220 and 224 are adjacent to coating 280. In the illustrated embodiment, deck sheets 204 and 206 are rectangular. In one embodiment, deck sheets 204 and 206 are preferably made of Kraft paper (manufactured by, for example, BZ Converting), solid fiber paper, or chipboard paper, although they may be made of other materials.

Peripheral side member 207 has a substantially flat inner surface 225 and a substantially flat outer surface 227. Peripheral side member 207 comprises first and second planar substantially parallel side portions 208 and 210, respectively, and first and second planar substantially parallel end portions 212 and 214, respectively. Inner surface 225 is adjacent to core 216. Outer surface 227 is adjacent to coating 280. In the illustrated embodiment, side portions 208 and 210 and end portions 212 and 214 are rectangular. In one embodiment, peripheral side member 207 is preferably made of Kraft paper (manufactured by, for example, BZ Converting), solid fiber paper, or chipboard paper, although it may be made of other materials. Peripheral side member 207 may be formed of one continuous length of material or it may be formed by multiple lengths of material joined together, such as, for example, by joining four separate pieces comprised of side portions 208 and 210 and end portions 212 and 214.

Peripheral side member 207 is substantially perpendicular to deck sheets 204 and 206, and circumscribes core 216. Together, deck sheets 204 and 206 and peripheral side member 207 enclose core 216.

Core 216 is an array of four-sided cells 250 arranged like a honeycomb. The shape of core 216 corresponds to the shape of bulkhead 200. If bulkhead 200 is rectangular, then core 216 is also rectangular. Cells 250 are preferably square, but may be diamond shaped. Each cell 250 has four walls 252 which define an opening 254. Each cell 250 has a plurality of first face edges 256 and a plurality of second face edges 258. First face edges 256 are spaced apart from and are substantially parallel to second face edges 258. Core 216 has first side 260 and second side 262, and first end 264 and second end 266. Sides 260 and 262 and ends 264 and 266 are formed by the walls 252 of those cells 250 located on the periphery of core 216, thereby defining a plurality of peripheral cells. The peripheral cells have a plurality of spaced apart peripheral side edges 268. Peripheral side edges 268 are substantially perpendicular to the first and second face edges 256 and 258, respectively. Core 216 is sandwiched between first deck sheet 204 and second deck sheet 206 such that first and second deck sheets 204 and 206, respectively, are substantially perpendicular to walls 252 of cells 250. A plurality of first face edges 256 are attached to inner surface 218 of first deck sheet 204 and a plurality of second face edges 258 are attached to inner surface 222 of second deck sheet 206. Sides 260 and 262 and ends 264 and 266 are attached to inner surface 225 of peripheral side member 207 by a plurality of peripheral side edges 268. In one embodiment, core 216 is preferably made of non-test (single-walled) corrugated paper (manufactured by, for example, Georgia-Pacific), although it may be made of non-corrugated Kraft paper or other materials.

The size of cells 250 is preferably 2½ to 5½ inches, and most preferably 3¾ inches, measured as the length of one wall 252. Other cell sizes may be useful, including larger sizes or smaller sizes such as ⅜ to 1 inch.

Core 216 is adhered to deck sheets 204 and 206 of bulkhead member 202 with glue (Pacific Adhesives, PKG 3238 DX) or other adhesives. Core 116 is coupled to side portions 208 and 210 and end portions 212 and 214 of bulkhead member 202 with, for example, an adhesive or tape 290 coupling.

Bulkhead member 202 may be made any size that is useful for securing a particular load in a particular container. A useful size is a rectangle that is 45 inches wide by 89 inches long by 8 inches thick.

Encapsulation or coating 280 is made of the same material as coating 180 described above.

Encapsulation or coating 280 comprises a first face 282, a second face 284, and a circumscribing side face 286. Circumscribing side face 286 extends between and transitions into first face 282 and second face 284. Coating 280 is adhered to and covers the outside of bulkhead member 202, preferably in its entirety. First face 282 is adhered to outer surface 220 of deck sheet 204. Second face 284 is adhered to and covers outer surface 224 of deck sheet 206. Circumscribing side face 286 is adhered to and covers outer surface 227 of peripheral side member 207. The thickness of coating 280 may be about 0.040-0.045 inches, but other thicknesses may be useful. Increasing the thickness of coating 280 increases the strength of encapsulated bulkhead 200, although increasing the thickness of coating 280 may increase the cost of bulkhead 200.

Bulkhead member 202 may be formed by same steps as described above for bulkhead member 102.

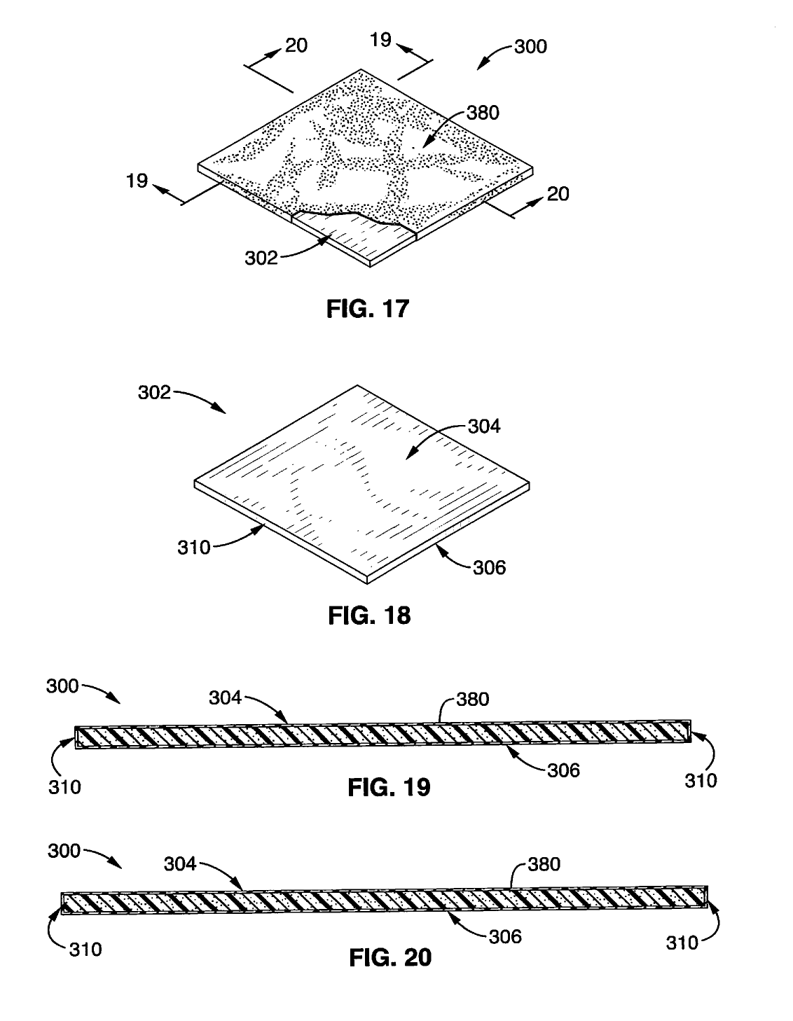

As illustrated in FIGS. 17 through 20, and in a further embodiment, encapsulated bulkhead 300 is comprised of bulkhead member 302 and encapsulation or coating 380. Bulkhead member 302 is preferably made of expanded polypropylene, although other types of material may be used. In one embodiment, a 1.3 lbs/cubic foot polypropylene may be used. Bulkhead 300 may be any three-dimensional geometric shape, such as a shape having rectangular, square, or other shaped sides, that is complemental to the shape of the space it is being used to fill. In the illustrated embodiment, encapsulated bulkhead 300 has rectangular sides.

Bulkhead member 302 comprises first and second planar substantially parallel faces or surfaces 304 and 306, respectively, and planar peripheral side face or surface 310.

Bulkhead member 302 may be any size that is useful for securing a particular load. A useful size is a rectangle that is 40 inches wide by 42 inches long by 1 inch thick.

Encapsulation or coating 380 is made of the same material as coating 180 described above.

Encapsulation 380 comprises a first face 382, a second face 384, and a circumscribing side face 386. Circumscribing side face 386 extends between and transitions into first face 382 and second face 384. Coating 380 is adhered to and covers the outside of bulkhead member 302, preferably in its entirety. First face 382 is adhered to and covers first face 304. Second face 384 is adhered to and covers second face 306. Circumscribing side face 386 is adhered to and covers peripheral side face 310. The thickness of coating 380 may be about 0.015-0.020 inches, but other thicknesses may be useful. Increasing the thickness of coating 380 increases the strength of encapsulated bulkhead 300, although increasing the thickness of coating 380 may increase the cost of bulkhead 300.

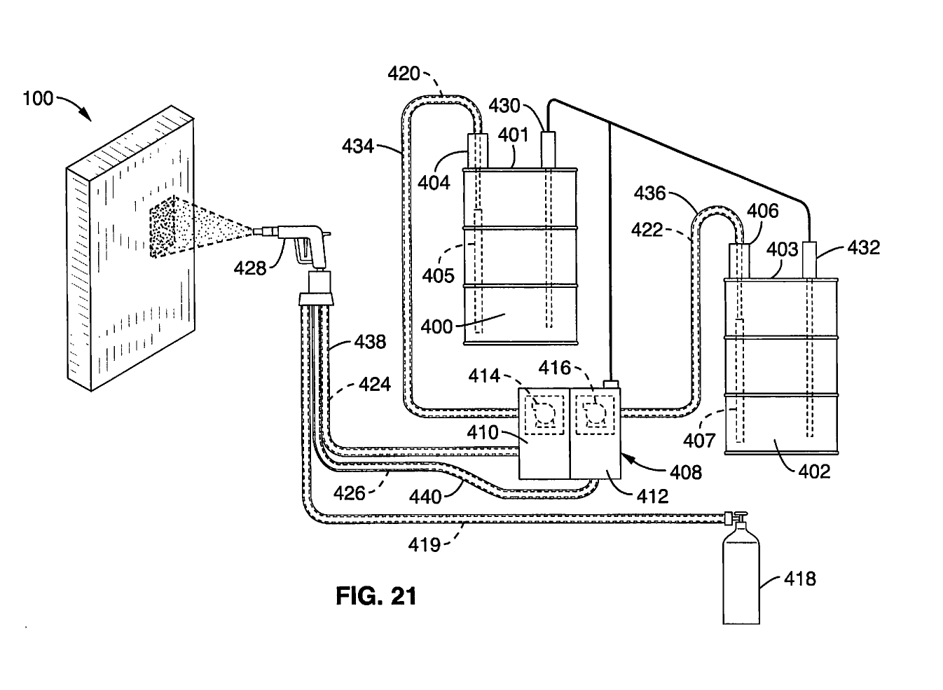

The system for encapsulating bulkhead member 102 is shown in FIG. 21 and is also used for encapsulating bulkhead members 202 and 302. In an embodiment in which coating 180, 280, or 380 is a polyurea formed by mixing two liquids, component A and component B, the system comprises: two containers, one each for component A and component B, which may be drum containers 400 and 402, respectively, as illustrated, or other types of containers; low pressure pumps 404 and 406 operatively coupled to drum containers 400 and 402, respectively; a spray coating proportioner machine 408 (such as the Graco Reactor E-XP2) having two separate compartments 410 and 412 and high pressure pumps 414 and 416 coupled to compartments 410 and 412, respectively; a compressed air source 418 with hose 419; hoses 420, 422, 424, and 426; means for heating component A and component B in the drums and in the hoses; and a spray gun 428.

Drum containers 400 and 402 may be any size or type of container, but are preferably 30 or 55 gallon metal drums. Low pressure pumps 404 and 406 may be low pressure drum pumps, and may be located on the external tops 401 and 403 of drums 400 and 402, respectively. Low pressure pumps 404 and 406 are operatively coupled to spray coating proportioner machine 408. Suction tubes or lines 405 and 407 extend from drum pumps 404 and 406, respectively, down inside the drums 400 and 402, respectively, almost to the bottom of the drums. Drums 400 and 402 preferably have heating probes 430 and 432, respectively, that extend inside the drum to heat the liquid contents of the drum. Heating probes 430 and 432 are operatively coupled to machine 408. Alternatively, drums 400 and 402 may be wrapped in an external heating blanket. Drums 400 and 402 are operatively coupled by way of hoses 420 and 422, respectively, from drum pumps 404 and 406, respectively, to compartments 410 and 412, respectively, of spray coating proportioner machine 408. Drum pumps 404 and 406, respectively, pump components A and B, respectively, into compartments 410 and 412, respectively, for subsequent spraying.

Compartments 410 and 412 have high pressure pumps 414 and 416, respectively, for pumping component A and component B, respectively, to spray gun 428 via respective hoses 424 and 426 operatively coupled between machine 408 and spray gun 428. Hoses 420, 422, 424, and 426 are covered with electric heating sleeves 434, 436, 438, and 440, respectively, or are heated by other means for heating components A and B as they pass through the hoses. Heating sleeves 434, 436, 438, and 440 are operatively coupled to machine 408.

Compressed air source 418 is operatively coupled via hose 419 to spray gun 428. Hose 419 may connect directly to spray gun 428 as illustrated in FIG. 21, or hose 419 may pass through machine 408 before connecting to spray gun 428. As noted above, spray gun 428 (such as the Graco Air Purge Spray Gun) is operatively coupled to air source 418 by way of hose 419 and to machine 408 by way of hoses 424 and 426. Spray gun 428 preferably has a flat tip with a rectangular opening.

An embodiment of a method for encapsulating bulkhead member 102 is comprised of the following steps and is also used for encapsulating bulkhead members 202 and 302. Initially, the power for spray coating proportioner machine 408 is turned on. The two liquid components A and B are placed or contained in drums 400 and 402, respectively, or other containers, and are heated at a setting of 140° F. on spray coating proportioner machine 408 with heating probes 430 and 432, respectively. Hoses 420, 422, 424, and 426 are heated with heating sleeves 434, 436, 438, and 440 such that components A and B remain at about 140° F. as they pass therethrough. Heating components A and B to higher temperatures, such as 170-175° F., has been found to cause the paper of bulkhead member 102 or 202 to bubble.

Then, components A and B are pumped out of drums 400 and 402, respectively, through hoses 420 and 422, respectively, into machine 408. The pressure of drum pumps 404 and 406 may be any low pressure that is sufficient to pump components A and B out of their drums and into machine 408. Components A and B are kept separate in machine 408 and are then pumped out of machine 408 by high pressure pumps 414 and 416, respectively, through hoses 424 and 426, respectively, into spray gun 428. The pressure in hoses 424 and 426 is preferably about 2800 psi. Compressed air is fed to spray gun 428 from compressed air source 418 at about 90 psi. Components A and B are mixed with the air, preferably at about 2800 psi. At a temperature of 140° F. and a pressure of about 2800 psi, components A and B will mix in the tip of spray gun 428 to form coating 180, or similarly, 280 or 380. The composition is sprayed out of spray gun 428, having a temperature of 125° F. at its tip, onto bulkhead member 102, or similarly, 202 or 302, such that all or substantially all of the surface area of the bulkhead member is covered. If bulkhead member 102 or 202 made of corrugated paper or other paper, respectively, is used, then the bulkhead member is sprayed evenly in one, two, or more passes to apply a coating 180 or 280, respectively, of about 0.040-0.045 inches thick. If polystyrene bulkhead member 302 is used, then the spraying is preferably done in one pass to apply a coating 380 of about 0.015-0.020 inches thick. A thicker coating 180, 280, or 380 may be applied to increase the strength of encapsulated bulkhead 100, 200, or 300. The thicknesses mentioned above minimize the cost of making encapsulated bulkhead 100, 200, or 300. When spraying these thicknesses, it will take about three minutes to flash and about 10 to 30 minutes for encapsulated bulkhead 100, 200, or 300 to dry or cure sufficiently to handle or to be stackable. In one embodiment, the encapsulation is cured under ambient conditions of humidity and temperature for a period of time sufficient for making an elastomeric encapsulated bulkhead having enhanced strength and moisture impermeability.

The components used to make coating 180, 280, or 380 may be hazardous to workers. Care should be taken in handling such components. For example, when coating 180, 280, or 380 is a polyurea, there is a potential for skin or eye contact with isocyanate compounds. Workers should be provided with and required to use appropriate personal protective clothing and equipment including coveralls, head cover, footwear, chemical-resistant gloves and eye protection, including goggles or full face-shield. Respiratory protection should also be employed.

Encapsulated bulkhead 100, 200, or 300 may be used in rail cars, trucks, or shipping containers with or without other types of void fillers to secure and protect cargo loads. Typically, the cargo loads, such as food or beverages in cans, bottles, large bins, or other containers, or fruits, vegetables, or frozen foods in crates, boxes, or other containers, are first placed in the rail car. Preferably, the cargo loads are placed at both ends of the rail car, extending toward the middle of the rail car, leaving a space or void along the longitudinal axis L in the medial section of the rail car. After the cargo loads are placed, one or more encapsulated bulkheads 100, 200, or 300 are placed in the space in the medial section of the rail car between the sections of cargo to fill the space such that there is no remaining space along longitudinal axis L.

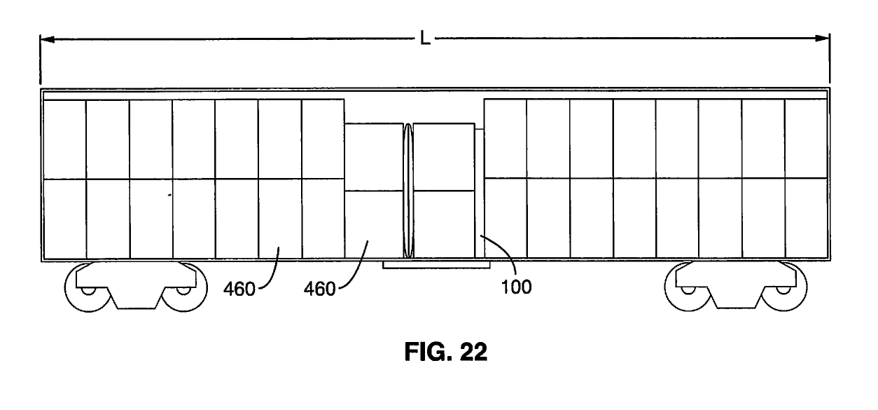

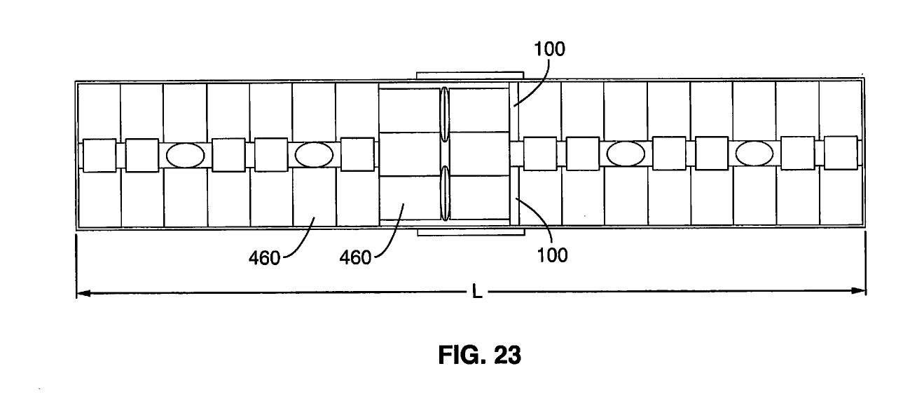

FIGS. 22 and 23 illustrate bulkhead 100, 200, or 300 in use in the medial section of a rail car interposed between cargo loads 460 to secure and protect the cargo loads 460. Several encapsulated bulkheads 100, 200, or 300, in any combination of sizes, may be placed next to each other to fill the space between the cargo loads 460. For example, if the space to be filled is 16 inches wide, two encapsulated bulkheads 100, 200, or 300 each 8 inches thick may be used next to each other to fill the space. If the space to be filled is 64 inches wide, then eight encapsulated bulkheads, 100, 200, or 300, each 8 inches thick, may be used next to each other.

The invention has been described above with the reference to the preferred embodiments. Those skilled in the art may envision other embodiments and variations of the invention that fall within the scope of the claims.

We claim:

1. An encapsulated bulkhead for securing loads, comprising:
a bulkhead member, wherein said bulkhead member comprises a first planar face, a second planar face spaced apart from and substantially parallel to the first planar face, and an outer peripheral side face;
an encapsulation covering and adhered to said bulkhead member wherein said encapsulation comprises a water-resistant coating; and
wherein said bulkhead member comprises expanded polypropylene.

2. The encapsulated bulkhead of claim 1, wherein said coating comprises a polyurea.

3. The encapsulated bulkhead of claim 2 wherein said polyurea is formed from isocyanate and an amine resin blend.

4. A method for making an encapsulated bulkhead, said method comprising the steps of:
providing a bulkhead member comprising a first planar face, a second planar face spaced apart from and substantially parallel to the first planar face, and an outer peripheral side face;
spraying the components of an elastomer onto an entirety of the first planar face, the second planar face, and the outer peripheral side face for encapsulating said bulkhead member; and
allowing said sprayed components to cure for a period of time sufficient for forming said elastomer.

5. The method of claim 4, wherein the bulkhead member is comprised of expanded polypropylene.

6. The method of claim 4, wherein the elastomer comprises a polyurea.

7. The method of claim 6, wherein said polyurea is formed from isocyanate and an amine resin blend.
